(19) United States
(12) Patent Application Publication
(10) Pub. No.: US 2024/0296818 A1
(43) Pub. Date: Sep. 5, 2024

(54) KEYBOARD UNIT

(71) Applicant: YAMAHA CORPORATION, Hamamatsu-shi (JP)

(72) Inventor: Akito OHBA, Hamamatsu-shi (JP)

(21) Appl. No.: 18/441,559

(22) Filed: Feb. 14, 2024

(30) Foreign Application Priority Data
Mar. 1, 2023 (JP) 2023-031426

(51) Int. Cl. G10H 1/34

(52) U.S. Cl. CPC G10H 1/346; G10H 2220/221; G10H 2220/265

(57) ABSTRACT

A keyboard unit includes a planar member, a frame, a key, a hammer assembly, and a stopper. The frame is supported by and attached to the planar member. The key is connected to the frame. The hammer assembly is rotationally movably mounted to the frame. The stopper is configured to restrict a rotational and downward movement of the hammer assembly. The stopper is softer in hardness than the frame. At least part of the stopper is disposed below an upper surface of the planar member.

### CROSS-REFERENCE TO RELATED APPLICATIONS

The present application claims priority under 35 U.S.C. § 119 to Japanese Patent Application No. 2023-031426, filed Mar. 1, 2023. The contents of this application are incorporated herein by reference in their entirety.

### BACKGROUND

### Field

The present disclosure relates to a keyboard unit.

### Background Art

Electronic musical instruments such as electric pianos are referred to as keyboard units. Keyboard units are typically required to be compact in size in their front-to-rear dimensions while providing levels of operational comfort comparable to the levels of operational comfort provided by acoustic pianos. JP 2009-145565 A and JP 2017-173700 A disclose hammer assemblies configured to collaborate with the keys of a keyboard unit to apply a load on the performer's fingers when pressing the keys to emulate the experience of playing an acoustic piano.

Hammer assemblies are provided for each one of the keys of a keyboard unit. This imposes a limit on the size of each hammer assembly in its scale direction. In order to apply a load to the performer's fingers in a manner similar to the load provided by an acoustic piano, it is necessary to elongate a weight member of the hammer assembly in the extending direction in which the keys extend. This can make it difficult to make a keyboard unit compact in its front-to-rear dimension.

The present disclosure has an object to make a keyboard unit compact in its front-to-rear dimension.

### SUMMARY

One aspect is a keyboard unit that includes a planar member, a frame, a key, a hammer assembly, and a stopper. The frame is supported by and attached to the planar member. The key is connected to the frame. The hammer assembly is rotationally movably mounted to the frame. The stopper is configured to restrict a rotational and downward movement of the hammer assembly. The stopper is softer in hardness than the frame. At least part of the stopper is disposed below an upper surface of the planar member.

Another aspect is a keyboard unit that includes a planar member, a frame, a key, and a hammer assembly. The frame is supported by and attached to the planar member. The key is connected to the frame. The hammer assembly is disposed above the first planar portion and rotationally movable so that part of the hammer assembly is movable below an upper surface of the planar member.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the following figures.

FIG. 1 is a schematic illustration of a configuration of a keyboard unit according to a first embodiment of the present disclosure.

FIG. 2 is a block diagram illustrating a configuration of a sound source device according to the first embodiment of the present disclosure.

FIG. 3 is a schematic illustration of an internal configuration of an enclosure according to the first embodiment of the present disclosure as seen from a side surface of the enclosure.

FIG. 4 is a schematic illustration of a configuration of a hammer assembly and a planar member according to the first embodiment of the present disclosure.

FIG. 5 is a schematic illustration of a configuration of the hammer assembly and the planar member according to the first embodiment of the present disclosure.

FIG. 6 is a schematic illustration of a configuration of the hammer assembly and the planar member according to the first embodiment of the present disclosure.

FIG. 7 is a schematic illustration of a configuration of the hammer assembly and the planar member according to the first embodiment of the present disclosure.

FIG. 8 is a schematic illustration of a configuration of the hammer assembly and the planar member according to the first embodiment of the present disclosure.

FIG. 9 is a schematic illustration of a configuration of the hammer assembly and the planar member according to a second embodiment of the present disclosure.

FIG. 10 is a schematic illustration of a configuration of the hammer assembly and the planar member according to the second embodiment of the present disclosure.

FIG. 11 is a schematic illustration of a configuration of the hammer assembly and the planar member according to the second embodiment of the present disclosure.

FIG. 12 is a schematic illustration of a configuration of the hammer assembly and the planar member according to the second embodiment of the present disclosure.

FIG. 13 is a schematic illustration of an internal configuration of the enclosure according to a third embodiment of the present disclosure as seen from a side surface of the enclosure.

FIG. 14 is a schematic illustration of a configuration of the hammer assembly and the planar member according to the third embodiment of the present disclosure.

FIG. 15 is a schematic illustration of a configuration of the hammer assembly and the planar member according to the third embodiment of the present disclosure.

FIG. 16 is a schematic illustration of a configuration of the hammer assembly and the planar member according to the third embodiment of the present disclosure.

FIG. 17 is a schematic illustration of a configuration of the hammer assembly and the planar member according to the third embodiment of the present disclosure.

### DESCRIPTION OF THE EMBODIMENTS

The present development is applicable to a keyboard unit.

Embodiments of the present disclosure will be described in detail by referring to the accompanying drawings. The embodiments presented below serve as illustrative examples of the present disclosure and are not intended to limit the scope of the present disclosure. In the accompanying drawings referenced in the embodiments, similar reference numerals, characters, or symbols may be used to indicate corresponding or identical elements. For example, to distinguish like elements, “A” may be appended to a reference numeral and “B” may be appended to the same reference numeral. Also in the accompanying drawings, for descriptive purposes, the dimension ratios (including ratios between configurations or elements, and ratios between vertical, lateral, and longitudinal directions) may differ from actual dimension ratios. Also in the accompanying drawings, for descriptive purposes, portions of a configuration may be excluded from the illustration. Terms indicating direction and associated with direction, such as “up,” “upper,” “upward,” “upper end,” “down,” “lower,” “downward,” and “lower end,” are used in reference to the vertical directions as depicted in each drawing. It is to be noted, however, that the vertical directions signify relative relationships that may be inverted or reversed.

### 1. First Embodiment

### 1-1. Configuration of Keyboard Unit

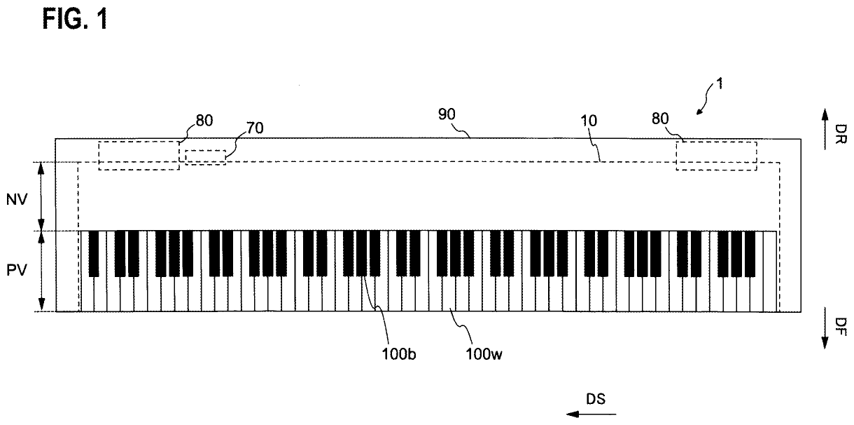

FIG. 1 is a schematic illustration of a configuration of a keyboard unit 1 according to a first embodiment. The keyboard unit 1 is an electronic keyboard instrument that emits sound in response to a key pressing by a user (performer). An example of the keyboard unit 1 is an electric piano. The keyboard unit 1 may be a keyboard type controller that outputs control data (for example, MIDI) based on a key pressing to control an external sound source device. In this case, the keyboard unit 1 may not necessarily include a sound source device.

The keyboard unit 1 includes a keyboard assembly 10. The keyboard assembly 10 includes a plurality of white keys 100w and a plurality of black keys 100b. In the following description, in a context where the white keys 100w and the black keys 100b need not be distinguished from each other, the white keys 100w and the black keys 100b will be collectively referred to as keys 100 or key 100. The white keys 100w and the black keys 100b are aligned with each other. The number of the keys 100 may be N. In this example, the number of the keys 100 is 88. The direction in which the keys 100 are aligned will be referred to as scale direction (DS direction). The keyboard unit 1 has a longitudinal direction in the DS direction. In the following description, a configuration denoted by a reference numeral appended with “w” is intended as a configuration corresponding to white key. Also in the following description, a configuration denoted by a reference numeral appended with “b” is intended as a configuration corresponding to black key.

The keyboard assembly 10 is partially disposed inside an enclosure 60 of the keyboard unit 1. In a top view of the keyboard unit 1, the part of the keyboard assembly 10 which part is covered by the enclosure 60 will be referred to as non-exterior part NV, and the part of the keyboard assembly 10 which part is exposed from the enclosure 60 and visually recognizable by the user will be referred to as exterior part PV. In other words, the exterior part PV is part of the keys 100 and is a region that can be played by the user. In the following description, the part of the keys 100 which part is exposed from the exterior part PV may be occasionally referred to as key body.

In the enclosure 60, a sound source device 70 and a speaker 80 are disposed. The sound source device 70 generates a sound waveform signal in response to a pressing of a key 100. The speaker 80 outputs the sound waveform signal generated by the sound source device 70 to external space. The keyboard unit 1 may include elements such as a slider that controls sound volume, a switch that changes tone, and a display that displays various kinds of information.

In the following description, the performer playing the keyboard unit 1 views directions such as up, down, left, right, front (DF direction), and rear (DR direction). For example, the non-exterior part NV can be described as being disposed further rearward (in the DR direction) than the exterior part PV. Also in the following description, directions may be described based on the keys 100, such as key front end side (key front side) and key rear end side (key rear side). In this case, the key front end side is defined as the front (DF direction) side of the keys 100 as seen from the performer. The key rear end side is defined as the rearward (DR direction) side of the keys 100 as seen from the performer. Each black key 100b includes an upward protruding portion that protrudes upward above the white keys 100w. According to the above definitions, the upward protruding portion can be described as extending between the front end and the rear end of the key body of the each black key 100b.

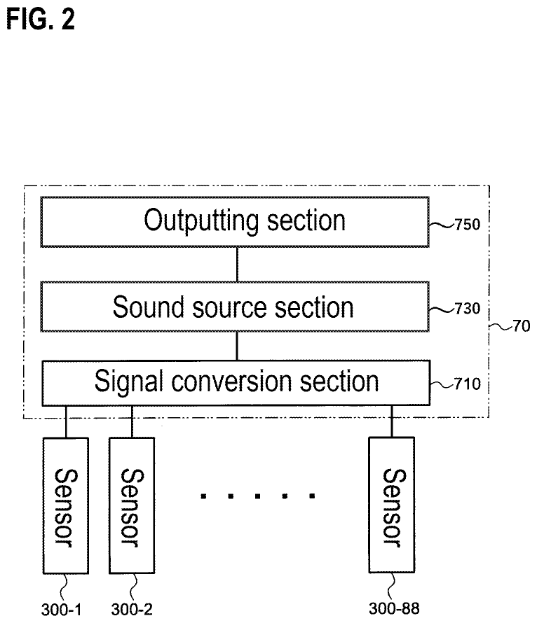

FIG. 2 is a block diagram illustrating a configuration of the sound source device 70 according to the first embodiment. The sound source device 70 includes a signal conversion section 710, a sound source section 730, and an outputting section 750. Sensors 300 are provided for the respective keys 100. Each sensor 300 detects a key pressing and outputs a signal based on the detected key pressing. In this example, the each sensor 300 outputs a signal based on three levels of key pressing strength. The velocity of key pressing can be detected based on the time intervals between such signals.

The sensors 300 include sensors 300-1, 300-2, . . . , 300-88, which correspond to the 88 keys 100. The signal conversion section 710 obtains signals output from these sensors, and generates and outputs an operation signal that is based on an operation state of each key 100. In this example, the operation signal is a signal of MIDI format. The signal conversion section 710 outputs a note-on based on a key pressing. The signal conversion section 710 also outputs: a key number (No.) indicating which of the 88 keys 100 has been operated (pressed); and a velocity corresponding to the velocity of key pressing. The key number No. and the velocity are linked to the note-on. In response to a key un-pressing, the signal conversion section 710 outputs a key No. and a note-off linked to each other. The signal conversion section 710 may receive a signal that is based on any other operation such as pedaling, and this signal may be reflected in the operation signal output from the signal conversion section 710.

The sound source section 730 generates a sound waveform signal based on the operation signal output from the signal conversion section 710. The outputting section 750 outputs the sound waveform signal generated by the sound source section 730. This sound waveform signal is output to, for example, the speaker 80 or a sound waveform signal output terminal.

### 1-2. Configuration of Keyboard Assembly

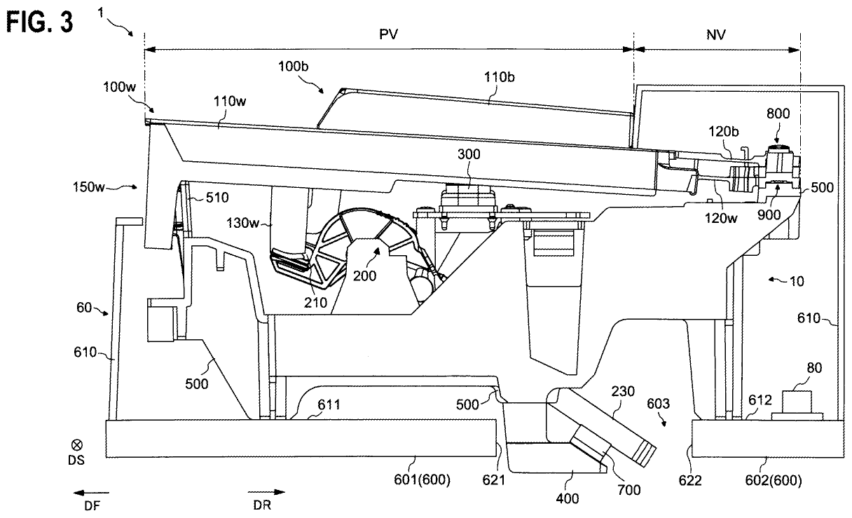

FIG. 3 is a schematic illustration of an internal configuration of the enclosure 60 according to the first embodiment, as seen from a side surface of the enclosure 60. In the following description, configurations such as a hammer assembly 200, a stopper rail 400, a planar member 600, and a stopper 700 will be described in relation to the white keys 100w. These configurations, however, are also applicable to the black keys 100b. As illustrated in FIG. 3, the keyboard assembly 10 and the speaker 80 are disposed in the enclosure 60. The speaker 80 is disposed at a far side of the keyboard assembly 10. The speaker 80 is provided to output sound upward and downward in the enclosure 60 in response to a key pressing. The sound output downward proceeds to outside the enclosure 60 through the lower surface of the enclosure 60. The sound output upward passes through the space inside keyboard assembly 10 from inside the enclosure 60, and proceeds to outside through the gaps between adjacent white keys 100w in the exterior part PV or through gaps between the white keys 100w and the enclosure 60.

A configuration of the keyboard assembly 10 will be described by referring to FIG. 3. The keyboard assembly 10 includes the white keys 100w, the hammer assembly 200, the sensors 300, the stopper rail 400, a frame 500, the planar member 600, the stopper 700, a connection member 800, and a receiving member 900. Most of the elements of the keyboard assembly 10 are resin structures produced by injection molding, excluding a weight member 230 of the hammer assembly 200 and the stopper 700.

The enclosure 60 includes the planar member 600 and a frame member 610. The planar member 600 constitutes the bottom of the enclosure 60. The frame member 610 is disposed at an upper portion of the planar member 600. A through hole 603 is disposed at part of the planar member 600. The planar member 600 includes a first planar portion 601 and a second planar portion 602. The first planar portion 601 is part of the planar member 600 which part is disposed at the front side relative to the through hole 603 in the DF direction. The second planar portion 602 is part of the planar member 600 which part is disposed at the rear side of the through hole 603 in the DR direction. As illustrated in FIG. 3, the first planar portion 601 and the second planar portion 602 are separated from each other by the through hole 603. It is to be noted, however, that the first planar portion 601 and the second planar portion 602 are connected to each other in the scale direction (which is not illustrated in FIG. 3). That is, the first planar portion 601 and the second planar portion 602 are parts integral to the planar member 600. While the planar member 600 is a resin structure (as described above), the planar member 600 may be an integral woody planar member. The integral woody planar member may be made of wood material. In this case, the planar member 600 and the frame member 610 may be different materials.

The frame 500 is supported by and fastened to the upper surface of the planar member 600. In the example illustrated in FIG. 3, a front half of the frame 500 in the DF direction is supported by and fastened to the upper surface, 611, of the first planar portion 601. A rear half of the frame 500 in the DR direction is supported by and fastened to the upper surface, 612, of the second planar portion 602. The frame 500 is connected to the planar member 600 with fastening members such as threads. The upper surface of the planar member 600 may be planar, or the part of the upper surface supporting and fastening the frame 500 may protrude upward beyond the other parts of the upper surface.

The stopper rail 400 is fixed to the frame 500 and protrudes downward from a lower portion of the frame 500. The stopper rail 400 protrudes downward through the through hole 603 and below the lower surface of the planar member 600. That is, the stopper rail 400 is disposed between the first planar portion 601 and the second planar portion 602 and below the upper surfaces 611 and 612. In other words, the stopper rail 400 is disposed in a region defined between a side wall 621 of the first planar portion 601 and a side wall 622 of the second planar portion 602. The stopper rail 400 has an L shape. A leading end portion of the stopper rail 400 extends rearward (in the DR direction).

The stopper rail 400 extends in the scale direction and is provided as a common element among a plurality of keyboard assemblies 10. The stopper rail 400 may be provided as a common element among all the keyboard assemblies 10 disposed in the keyboard unit 1, or may be provided as a common element among keyboard assemblies 10 of 1 octave.

The stopper rail 400, at its leading end portion, has a tapered shape whose thickness decreases in the direction toward the end of the leading end portion. The tapered shape defines an inclined surface of the leading end portion of the stopper rail 400. The stopper 700 is disposed at the inclined surface. The inclination angle of the inclined surface depends on the angle that the weight member 230, described later, forms with the stopper 700.

The configuration of the stopper rail 400 will not be limited to the above-described configuration. Another possible example is that the stopper rail 400 is connected to the frame 500 at a position further rearward (in the DR direction) than the stopper 700, and has an L shape that extends downward from the frame 500 and whose leading end portion extends frontward (in the DF direction).

The stopper 700 is softer in hardness than the stopper rail 400, the frame 500, and the planar member 600. The stopper 700 is made of a shock-absorbing material. For example, the stopper 700 may be a non-woven fabric, an elastic material, or a laminated body of the non-woven fabric and the elastic material. The stopper 700 restricts a rotational and downward movement of the hammer assembly 200 (in particular, the weight member 230), described later. The stopper 700 is disposed between the first planar portion 601 and the second planar portion 602 and below the upper surfaces 611 and 612. In other words, the stopper 700 is disposed in the region defined between the side wall 621 of the first planar portion 601 and the side wall 622 of the second planar portion 602.

The stopper 700 extends in the scale direction and is provided as a common element among the plurality of keyboard assemblies 10. The stopper rail 400 may be provided as a common element among all the keyboard assemblies 10 disposed in the keyboard unit 1, or may be provided as a common element among keyboard assemblies 10 of 1 octave. In FIG. 3, the entirety of the stopper 700 is disposed below the upper surfaces 611 and 612. This configuration, however, is not intended in a limiting sense. The stopper 700 may be partially disposed below the upper surfaces 611 and 612.

The receiving member 900 is fixed to the frame 500. The connection member 800 is mounted on the receiving member 900, and connects the white key 100w to the frame 500 rotationally movably relative to the frame 500. The white key 100w includes a key body 110w and a key support 120w. The key body 110w is connected to the connection member 800 via the key support 120w. The key support 120w is a planar member. Part of the key support 120w is thinner in the plate thick direction than the other parts of the key support 120w. This part of the key support 120w has a flexibility that enables the part of the key support 120w to bend to cause the white key 100w to rotationally move relative to the frame 500.

The white key 100w includes a front end key guide 150w. The front end key guide 150w slidably contacts a front end frame guide 510 of the frame 500 and covers the front end frame guide 510. The front end key guide 150w has an upper portion and a lower portion in the DS direction. At both the upper portion and the lower portion, the front end key guide 150w is in contact with the front end frame guide 510. The black key 100b, by contrast, is not provided with a member corresponding to the front end key guide 150w.

The hammer assembly 200 is rotationally movable relative to a shaft disposed at the frame 500. The hammer assembly 200 includes a shaft receiving member that is rotationally movably mounted on the shank portion. The hammer assembly 200 includes a front end member 210. The front end member 210 contacts a hammer support 130w at the white key 100w in the internal space of the hammer support 130w. Specifically, the front end member 210 contacts the hammer support 130w slidably approximately in front and/or rear directions. The portion at which the front end member 210 and the hammer support 130w contact each other will be referred to as sliding contact portion. This sliding contact portion is positioned below the white key 100w at the exterior part PV (at a position ahead of the rear end of the key body 110w).

The hammer assembly 200 includes the weight member 230. The weight member 230 is made of metal and disposed at a far side of the rotational movement axis of the hammer assembly 200. At key detachment time (key un-pressing time), the weight member 230 is in contact with the stopper 700, which is disposed under the weight member 230, causing the front end member 210 of the hammer assembly 200 to press the white key 100w upward. In response to a key pressing, the weight member 230 moves upward and collides with a stopper (not illustrated) disposed above the weight member 230. That is, the hammer assembly 200 rotationally moves based on a movement of the white key 100w. The weight member 230 causes the hammer assembly 200 to apply a key pressing load to the performer's finger. The stopper disposed above the weight member 230 is made of a shock-absorbing material (such as a non-woven fabric and an elastic material), similarly to the stopper 700.

As illustrated in FIG. 3, at key detachment time, the hammer assembly 200 is positioned below the upper surfaces 611 and 612. More specifically, the hammer assembly 200 is disposed above the upper surfaces 611 and 612 and is rotationally movable to below the upper surfaces 611 and 612 between the first planar portion 601 and the second planar portion 602. In other words, the hammer assembly 200 is rotationally movable to the region defined between the side wall 621 of the first planar portion 601 and the side wall 622 of the second planar portion 602. Furthermore, the weight member 230 and the stopper 700 contact each other below the upper surfaces 611 and 612.

Above the weight member 230, the sensor 300 is mounted on the frame 500. Upon pressing of the key, the sensor 300 is pressed down at the upper surface of the weight member 230. Upon pressing of the sensor 300, the sensor 300 outputs a detection signal. The sensors 300 are provided for the respective keys 100, as described above.

### 1-3. Challenges Involved in Compactness of Keyboard Unit

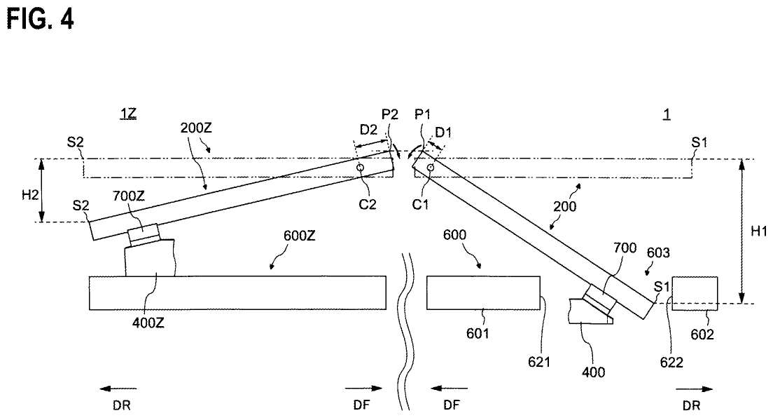

By referring to FIG. 4, description will be made with regard to challenges involved in compactness in size of the keyboard unit 1 in its front-to-rear dimension. FIG. 4 is a schematic illustration of a configuration of the hammer assembly and the planar member according to the one embodiment of the present disclosure. The right half area of FIG. 4 is a conceptual illustration of the hammer assembly 200 and part of the planar member 600 according to the one embodiment. The left half area of FIG. 4 is a conceptual illustration of a conventional hammer assembly 200Z and part of a conventional planar member 600Z.

FIG. 4 schematically illustrates the hammer assemblies 200 and 200Z, the planar members 600 and 600Z, the stopper rails 400 and 400Z, and the stoppers 700 and 700Z. The hammer assembly 200 is rotationally movable about a rotational movement axis C1. The hammer assembly 200Z is rotationally movable about a rotational movement axis C2. The hammer assemblies 200 and 200Z at key detachment time are illustrated in solid lines, and the hammer assemblies 200 and 200Z at key pressing time are illustrated in double-dashed lines. At the point of application P1, the hammer assembly 200 receives force from the hammer support 130w (see FIG. 3), which is disposed at the key. At the point of application P2, the hammer assembly 200Z receives force from the hammer support. In the longitudinal direction of the hammer assembly 200, the distance between the point of application P1 and the rotational movement axis C1 is D1. In the longitudinal direction of the hammer assembly 200Z, the distance between the point of application P2 and the rotational movement axis C2 is D2. D1 is smaller than D2.

The amount of key pressing in the keyboard unit 1 according to the one embodiment is identical to the amount of key pressing in a conventional keyboard unit 1Z. In the one embodiment, in order to reduce the size of the keyboard unit 1 in its front-to-rear dimension, it is necessary to reduce the size of (shorten) the hammer assembly 200 in its longitudinal direction. If the hammer assembly 200 is shortened, the weight of the hammer assembly 200 reduces. In order to maintain the key pressing load, it is necessary to enlarge the weight member 230 of the hammer assembly 200 in thickness, or it is necessary to use a different material for the weight member 230. There is, however, a limitation on the thickness of the weight member 230 in order to avoid interference between adjacent hammer assemblies 200 and between the hammer assembly 200 and the frame 500. Another consideration is that as the weight of the material of the weight member 230 increases per unit volume, the cost of the material also rises.

In light of these challenges, it has been necessary to make the distance between the rotational movement axis C1 and the point of application P1 shorter than the distance between the rotational movement axis C2 and the point of application P2. This configuration ensures that the force (key pressing load) necessary at the point of application P1 for the rotational movement of the hammer assembly 200 is identical to the force (key pressing load) necessary at the point of application P2 for the rotational movement of the hammer assembly 200Z, even in a case where the hammer assembly 200 is shorter than the hammer assembly 200Z.

At key pressing time and key detachment time, a leading end portion S1 of the hammer assembly 200 moves over a vertical movement distance of H1, and a leading end portion S2 of the hammer assembly 200Z moves over a vertical movement distance of H2. As described above, the amount of key pressing in the keyboard unit 1 is identical to the amount of key pressing in the keyboard unit 1Z. Therefore, the vertical movement distance H1 is greater than the vertical movement distance H2. Since the space over the hammer assembly 200 is occupied by the key, it is necessary to secure a large space below the hammer assembly 200 for the rotational movement range of the hammer assembly 200. In light of this necessity, a configuration employed is that the through hole 603 is disposed at the planar member 600, which is part of the enclosure 60, that elements such as the stopper rail 400 and the stopper 700 are disposed in the through hole 603, and that the rotational movement range of the hammer assembly 200 extends to the inside of the through hole 603.

Thus, the downward rotational movement range of the hammer assembly 200 is increased in the keyboard unit 1 according to the one embodiment. The increase in the downward rotational movement range ensures that the distance between the rotational movement axis C1 and the point of application P1 is shortened. This ensures that the hammer assembly 200 can be shortened. As a result, the keyboard unit 1 can be made compact in size in the front-to-rear dimension of the keyboard unit 1.

### 1-4. Modifications of First Embodiment

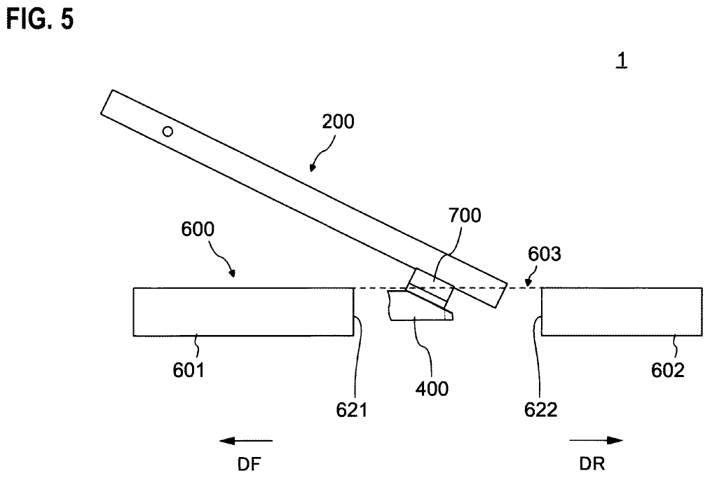

In FIGS. 3 and 4, part of the stopper rail 400 is positioned below the lower surface of the planar member 600. Also in FIGS. 3 and 4, the entirety of the stopper 700 is positioned below the upper surfaces 611 and 612 of the planar member 600. Also in FIGS. 3 and 4, the rotational movement range of the hammer assembly 200 extends to below the lower surface of the planar member 600. This configuration, however, is not intended in a limiting sense. For example, as illustrated in FIG. 5, the stopper rail 400 may be positioned above the lower surface of the planar member 600. Part of the stopper 700 may be positioned above the upper surfaces 611 and 612. The rotational movement range of the hammer assembly 200 may not necessarily extend to the lower surface of the planar member 600.

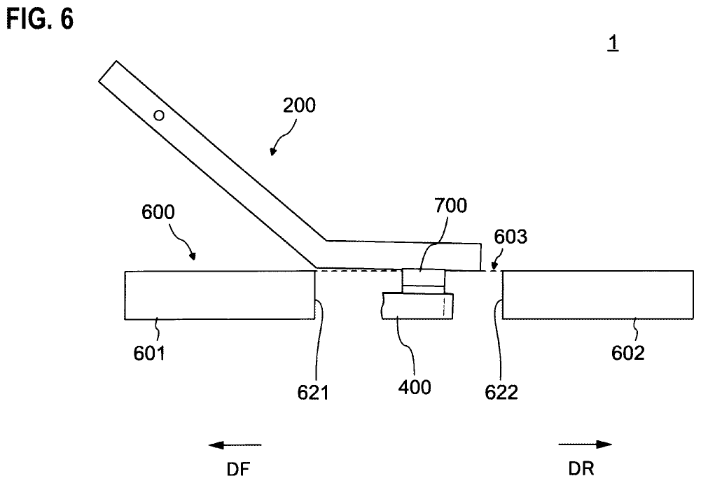

Another modification of the first embodiment is illustrated in FIG. 6. As illustrated in FIG. 6, the rotational movement range of the hammer assembly 200 may not necessarily extend to below the upper surfaces 611 and 612 of the planar member 600. In this case, it suffices that at least part of the stopper rail 400 or part of the stopper 700 is disposed below the upper surfaces 611 and 612. In this configuration as well, the rotational movement range of the hammer assembly 200 can be extended further downward than a conventional configuration.

In the example illustrated in FIG. 6, the stopper rail 400 is disposed between the lower surface of the planar member 600 and the upper surfaces 611 and 612 of the planar member 600, and an upper end portion of the stopper 700 is positioned slightly above the upper surfaces 611 and 612. Also in the example illustrated in FIG. 6, the hammer assembly 200 is bent such that a leading end portion of the hammer assembly 200 is approximately parallel to the upper surfaces 611 and 612 in a state in which the hammer assembly 200 is in contact with the stopper 700. Thus, even in a case where the rotational movement range of the hammer assembly 200 does not extend to below the upper surfaces 611 and 612, the rotational movement range is sufficiently wide.

In the one embodiment, the stopper rail 400 and the frame 500 have been described as being different configurations. The stopper rail 400 and the frame 500 may be integral to each other. In this case, the stopper rail 400 can be regarded as being an element included in the frame 500. The stopper rail 400 can be referred to as “stopper installation portion.” In this case, the stopper 700 can be regarded as being fixed to the stopper installation portion.

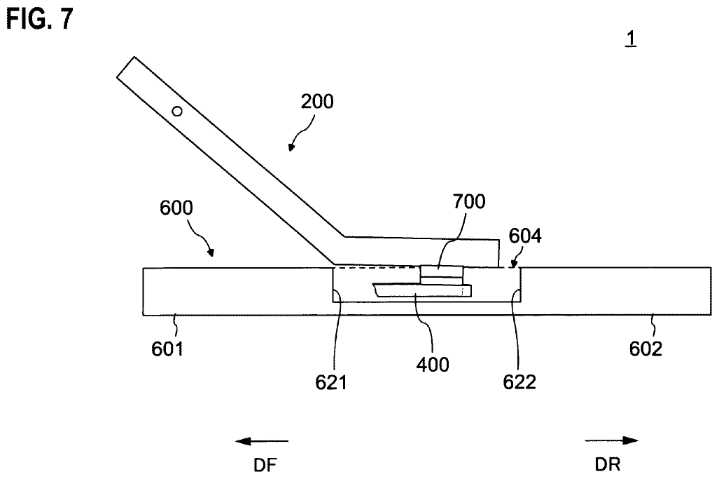

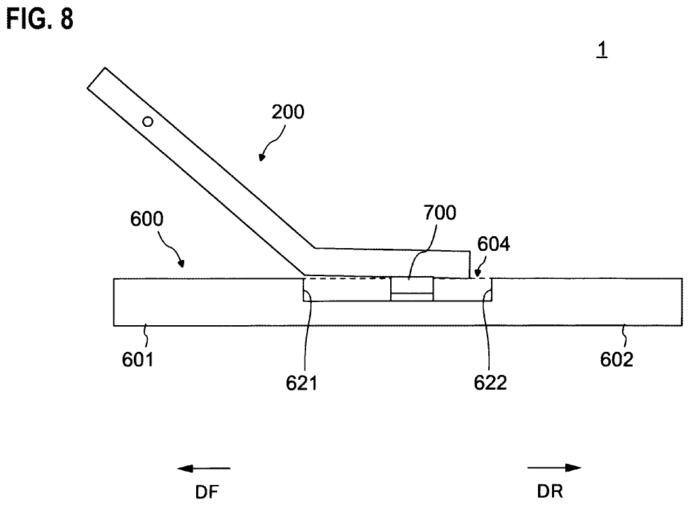

In the example illustrated in FIGS. 4 to 6, the through hole 603 is disposed at the planar member 600. This configuration, however, is not intended in a limiting sense. For example, as illustrated in FIG. 7, a recess 604 may be disposed at the planar member 600. In FIG. 7, the stopper rail 400 is connected to the frame 500 (which is not illustrated), and is disposed at a position spaced upward from the bottom of the recess 604. It is to be noted, however, that the stopper rail 400 may be in contact with the bottom of the recess 604. FIG. 7 is otherwise similar in configuration to FIG. 6 and will not be elaborated further upon here. Alternatively, as illustrated in FIG. 8, the stopper 700 may be fixed to the bottom of the recess 604. In this case, it is not necessary to provide the stopper rail 400 in the recess 604.

In the configurations of FIGS. 7 and 8 as well, the part of the planar member 600 which part is disposed at the front side of the through hole or recess in the DF direction will be referred to as first planar portion 601, and the part of the planar member 600 which part is disposed at the rear side of the through hole or recess will be referred to as second planar portion 602. In this case, the first planar portion 601 and the second planar portion 602 can be regarded as being separated from each other by the recess 604, which is disposed at the planar member 600. In this case as well, the first planar portion 601 and the second planar portion 602 are elements included in the integral planar member 600.

While in the examples illustrated in FIGS. 7 and 8, the hammer assembly 200 is bent, the hammer assembly 200 may be linear as illustrated in FIG. 5. In this case, the shape of the recess 604 may be adjusted based on the rotational movement range of the linear hammer assembly 200.

The above-described modifications provide advantageous effects similar to the advantageous effects provided by the first embodiment.

### 2. Second Embodiment

### 2-1. Configurations of Hammer Assembly and Planar Member

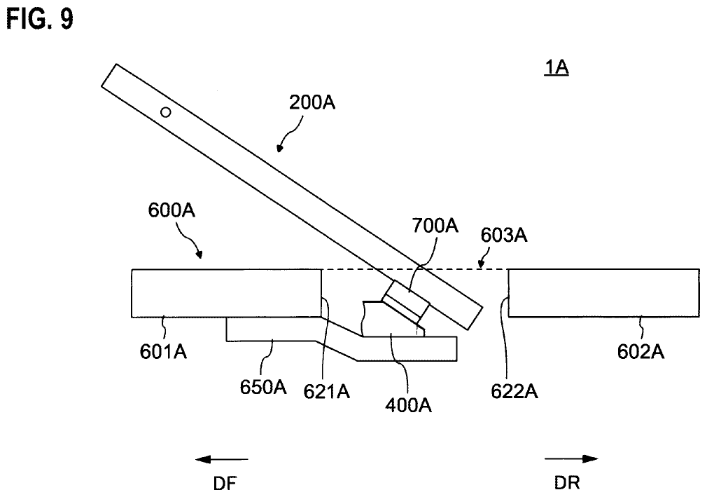

By referring to FIG. 9, a keyboard unit 1A according to a second embodiment will be described. FIG. 9 is a schematic illustration of a configuration of the hammer assembly and the planar member according to the second embodiment of the present disclosure, similarly to FIG. 5. The configuration illustrated in FIG. 9 is similar to the configuration illustrated in FIG. 5. The following description will mainly focus on configurations different from the first embodiment illustrated in FIG. 5, minimizing a description of a configuration similar to the first embodiment illustrated in FIG. 5. In a case where there is a need to describe a configuration similar to the first embodiment, “A” will be appended to the reference numerals of the elements illustrated in FIGS. 1 to 8.

As illustrated in FIG. 9, a cover 650A is disposed below the planar member 600A and the stopper rail 400A. In FIG. 9, the cover 650A is fixed to the lower surface of the first planar portion 601A and the lower surface of the stopper rail 400A (stopper installation portion). The cover 650A extends from the lower surface of the first planar portion 601A toward the through hole 603A, then bends downward, and extends toward the stopper rail 400A. That is, the cover 650A covers part of the space between the first planar portion 601A and the second planar portion 602A. This part extends frontward (in the DF direction) from approximately the center of the space. While in FIG. 9 the cover 650A is fixed to the lower surface of the stopper rail 400A, the cover 650A may be separated from the lower surface. Also, while in FIG. 9 the cover 650A is bent downward, the cover 650A may extend linearly from the lower surface of the first planar portion 601A toward the through hole 603A, without bending.

With the above-described configuration, the keyboard unit 1A according to the second embodiment provides the following advantageous effects, in addition to the advantageous effects provided by the one embodiment. In a view of the keyboard unit 1A as seen from below, elements such as the hammer assembly 200A and the stopper rail 400A can be hidden, and matter such as dirt is prevented from entering the keyboard unit 1A from below.

### 2-2. Modifications of Second Embodiment

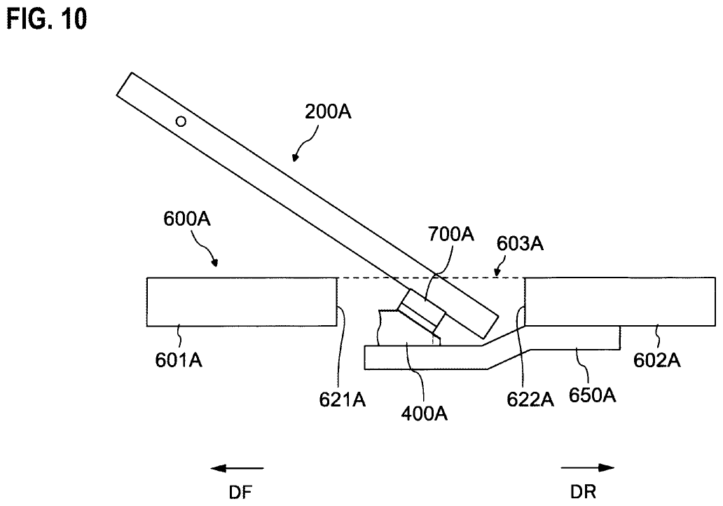

In FIG. 9, the cover 650A is fixed to the lower surface of the first planar portion 601A and the lower surface of the stopper rail 400A. This configuration, however, is not intended in a limiting sense. As illustrated in FIG. 10, the cover 650A may be fixed to the lower surface of the second planar portion 602A and the lower surface of the stopper rail 400A (stopper installation portion). That is, the cover 650A covers part of the space between the first planar portion 601A and the second planar portion 602A which part extends rearward (in the DR direction) from approximately the center of the space. In this case as well, the cover 650A may be separated from the lower surface of the stopper rail 400A. Also, the cover 650A may extend linearly from the lower surface of the second planar portion 602A toward the through hole 603A, without bending.

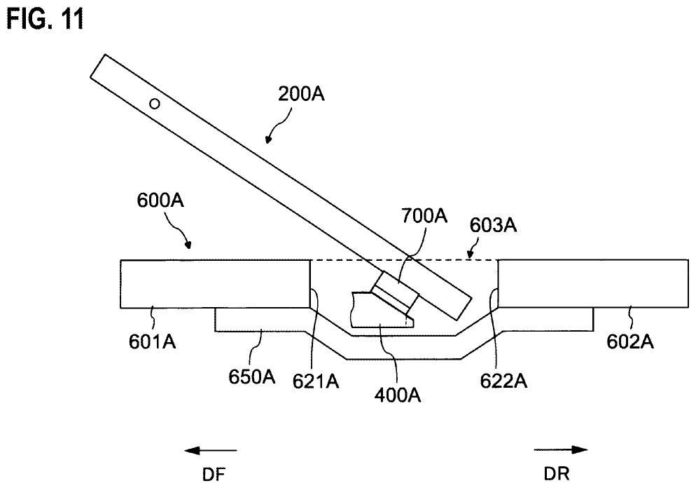

Another modification of the second embodiment is illustrated in FIG. 11. As illustrated in FIG. 11, the cover 650A may be fixed to both the lower surface of the first planar portion 601A and the lower surface of the second planar portion 602A. That is, the cover 650A covers all of the space between the first planar portion 601A and the second planar portion 602A. The cover 650A has a recessed shape extending from the first planar portion 601A and the second planar portion 602A toward the through hole 603A and then bending downward. While in FIG. 11 the stopper rail 400A is separated from the bottom of the cover 650A, the stopper rail 400A may be in contact with the bottom of the recessed cover 650A and fixed to the cover 650A.

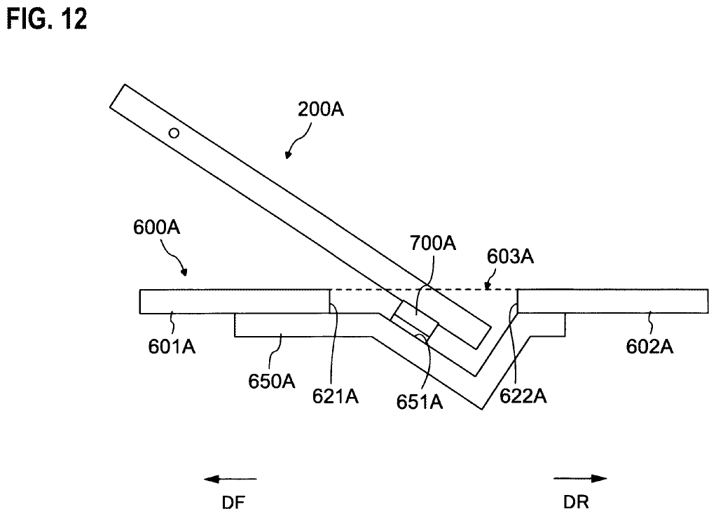

Another modification of the second embodiment is illustrated in FIG. 12. As illustrated in FIG. 12, the stopper 700A may be fixed to the cover 650A. In FIG. 12, the stopper 700A is fixed to an inclined surface 651A of the cover 650A. Similarly to the cover 650A illustrated in FIG. 11, the cover 650A is fixed to both the first planar portion 601A and the lower surface of the second planar portion 602A, and covers all of the space between the first planar portion 601A and the second planar portion 602A. In this case, it is not necessary to provide the stopper rail 400A at the recessed portion of the cover 650A. Also, the angle of the inclined surface of the recessed portion to which the stopper 700A is fixed can be adjusted based on the angle at which the hammer assembly 200A contacts the stopper 700A. For example, in a side view, in a state in which the hammer assembly 200A is in contact with the stopper 700A, the longitudinal direction of the hammer assembly 200 and the inclined surface 651A may be approximately parallel to each other.

Thus, the cover 650A may cover at least part of the space between the first planar portion 601A and the second planar portion 602A. For example, the cover 650A may cover part of the space between the first planar portion 601A and the second planar portion 602A which part at least includes the position at which the stopper 700A is provided.

### 3. Third Embodiment

### 3-1. Configuration of Hammer Assembly and Planar Member

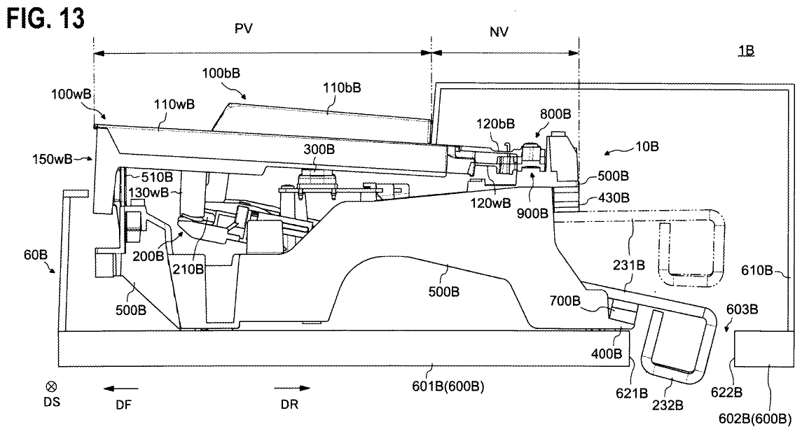

By referring to FIG. 13, a keyboard unit 1B according to a third embodiment will be described. FIG. 13 is a schematic illustration of an internal configuration of the enclosure according to the third embodiment of the present disclosure as seen from a side surface of the enclosure, similarly to FIG. 3. The configuration illustrated in FIG. 13 is partially different in shape from the configuration illustrated in FIG. 3. In FIGS. 3 and 13, however, elements appended with identical reference numerals, characters, or symbols have the same element names and perform the same functions. The following description will focus on those respects in which FIG. 13 is different from FIG. 3, omitting a description of elements appended with similar reference numerals, characters, or symbols in FIGS. 3 and 13. In a case where there is a need to describe a configuration similar to the first embodiment, “B” will be appended to the reference numerals of the elements illustrated in FIGS. 1 to 8.

As illustrated in FIG. 13, the hammer assembly 200B includes a weight member 231B. The weight member 231B includes a rectangular portion 232B at a leading end portion of the weight member 231B. The rectangular portion 232B has an approximately rectangular shape formed by folding the leading end portion a plurality of times. The rectangular portion 232B protrudes downward from the linear portion of the weight member 231B. The through hole 603B of the planar member 600B is disposed at a position corresponding to the rectangular portion 232B. Part of the rectangular portion 232B is positioned below the lower surface of the planar member 600B, penetrating the through hole 603B.

In the third embodiment, the frame 500B is supported by and fastened to the first planar portion 601B alone. Also, the stopper rail 400B and the stopper 700B are disposed above the upper surface of the planar member 600B. Since the rectangular portion 232B of the weight member 231B protrudes downward, the keyboard unit 1B can be made compact in size in the front-to-rear dimension of the keyboard unit 1B. Additionally, even when the key is pressed and the hammer assembly 200B is rotationally moved upward to contact the upper side stopper 430B (this hammer assembly 200B is indicated by double-dashed lines in FIG. 13), the space above the weight member 231B can be effectively used for other purposes.

### 3-2. Modifications of Third Embodiment

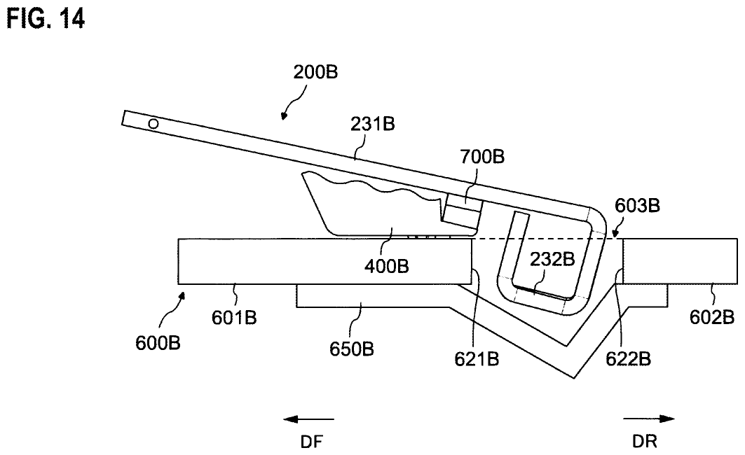

FIG. 14 is an illustration of the hammer assembly 200B, the stopper rail 400B, the planar member 600B, and the stopper 700B, extracted from the configuration illustrated in FIG. 13. As illustrated in FIG. 14, a cover 650B may be provided to cover the space between the first planar portion 601B and the second planar portion 602B from below the space. The cover 650B is fixed to the lower surface of the first planar portion 601B and the lower surface of the second planar portion 602B. The cover 650B has a recessed shape bent downward to avoid interference with the rectangular portion 232B.

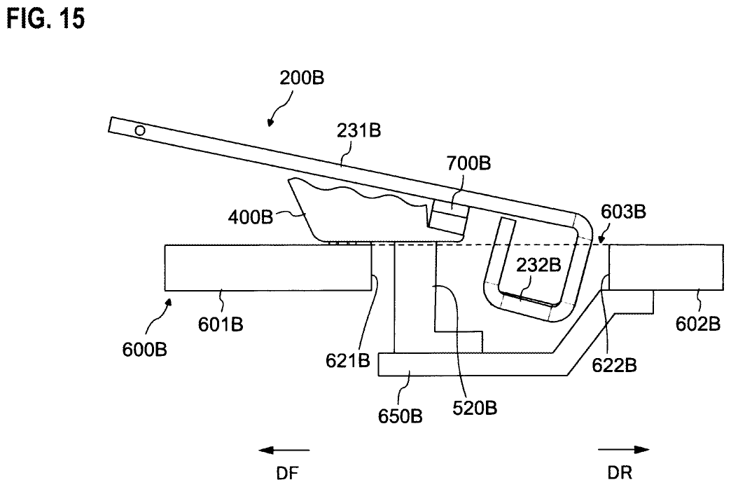

Another modification of the third embodiment is illustrated in FIG. 15. As illustrated in FIG. 15, the cover 650B may be fixed to the lower surface of a leg 520B, instead of to the first planar portion 601B. The leg 520B extends downward from the frame 500B. The leg 520B may extend downward from the stopper rail 400B. The leg 520B has an L shape that extends downward from the frame 500B and then bends rearward (in the DR direction). This L shape, however, is not intended to limit the shape of the leg 520B; the leg 520B may have any other shape. As opposed to FIG. 15, the leg 520B may be disposed at a position further rearward (in the DR direction) than the rectangular portion 232B, and the cover 650B may be fixed to the lower surface of the first planar portion 601B and the lower surface of the leg 520B, which is in this case disposed at a position further rearward (in the DR direction) than the rectangular portion 232B.

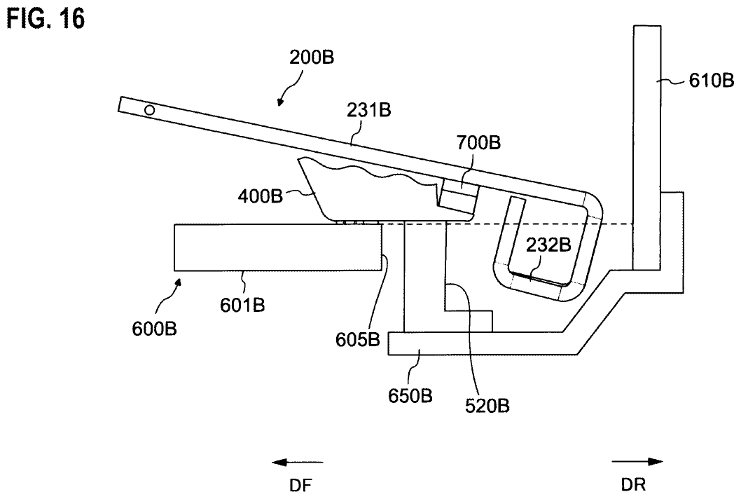

Another modification of the third embodiment is illustrated in FIG. 16. As illustrated in FIG. 16, the second planar portion 602B may not necessarily be provided. In this case, the cover 650B is fixed to the lower surface of the leg 520B and a rear side (the DR direction) surface of the frame member 610B. In this configuration, none of a through hole or a recess is disposed at the planar member 600B. A space is defined between a rear end portion 605B of the planar member 600B and the frame member 610B. The leg 520B, the cover 650B, and the rectangular portion 232B are disposed in this space.

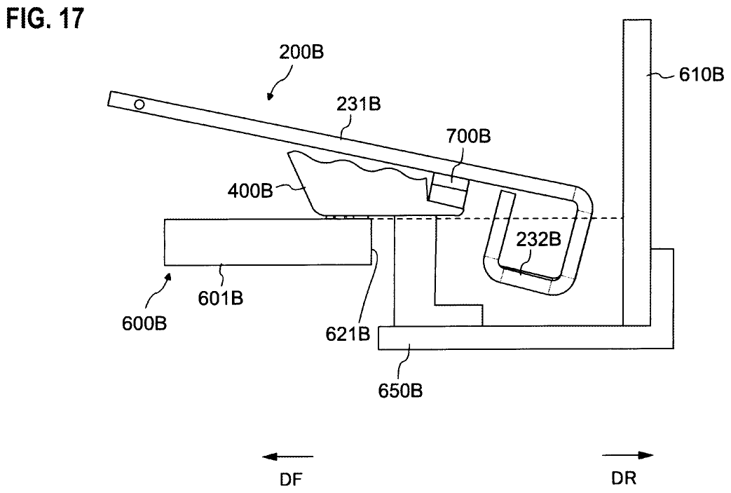

In the example illustrated in FIG. 16, the cover 650B extends from the bottom of the leg 520B toward the frame member 610B, which is disposed at a position further rearward (in the DR direction) than the cover 650B. Then, the cover 650B bends upward and contacts the rear side surface of the frame member 610B. Another possible example, illustrated in FIG. 17, is that the frame member 610B extends downward and the cover 650B linearly extends rearward (in the DR direction) from the bottom of the leg 520B to contact the rear side surface of the frame member 610B.

In the above-described embodiments, an electric piano has been described as a keyboard device example to which the hammer assembly is applied. Also in the above-described embodiments, the hammer assembly has been described as being provided for a key of the electric piano. The hammer assembly according to any of the above-described embodiments, however, is also applicable to devices other than electric pianos or to elements other than keys of electric pianos.

In the above-described embodiments, the planar member may include a first planar portion and a second planar portion. The frame may be supported by and connected to the first planar portion and the second planar portion. At least the part of the stopper may be disposed below an upper surface of the first planar portion and an upper surface of the second planar portion. The stopper may be disposed between the first planar portion and the second planar portion.

In the above-described embodiments, the first planar portion and the second planar portion may be integrally formed with the planar member. The planar member may include one of a through hole or a recess that spaces the first planar portion and the second planar portion from each other. At least the part of the stopper may be disposed in a region defined between a side wall of the first planar portion and a side wall of the second planar portion. The side wall of the second planar portion may face the side wall of the first planar portion across the through hole or the recess.

In the above-described embodiments, the frame may include a stopper installation portion. The stopper may be fixed to the stopper installation portion. The stopper installation portion may be disposed: below the upper surface of the first planar portion and the upper surface of the second planar portion; and between the first planar portion and the second planar portion.

In the above-described embodiments, the first planar portion and the second planar portion may be integrally formed with the planar member. The planar member may include a recess that spaces the first planar portion and the second planar portion from each other. The stopper may be fixed to a bottom of the recess.

In the above-described embodiments, the keyboard unit may further include a cover fixed to at least one of a lower surface of the first planar portion or a lower surface of the second planar portion. The first planar portion and the second planar portion may be spaced from each other. The cover may cover at least part of the space separating the first planar portion and the second planar portion.

In the above-described embodiments, the keyboard unit may further include a cover fixed to a lower surface of the first planar portion and a lower surface of the second planar portion. The first planar portion and the second planar portion may be spaced from each other. The cover may cover the space separating the first planar portion and the second planar portion. The stopper may be fixed to the cover.

In the above-described embodiments, the first planar portion and the second planar portion may be integrally formed with the planar member. The planar member may be made of wood material.

In the above-described embodiments, the planar member may include a first planar portion and a second planar portion. The frame may be supported by and connected to the first planar portion and the second planar portion. The part of the hammer assembly may be movable below an upper surface of the first planar portion, between the first planar portion and the second planar portion.

In the above-described embodiments, the keyboard unit may further include a stopper configured to restrict a rotational and downward movement of the hammer assembly, the stopper being softer in hardness than the frame. At least part of the stopper may also be disposed below the upper surface of the first planar portion and an upper surface of the second planar portion, between the first planar portion and the second planar portion.

In the above-described embodiments, the first planar portion and the second planar portion may be integrally formed with the planar member. The planar member may include one of a through hole or a recess that spaces the first planar portion and the second planar portion from each other. The part of the hammer assembly may be rotationally movable to a region defined between a side wall of the first planar portion and a side wall of the second planar portion. The side wall of the second planar portion may face the side wall of the first planar portion across the through hole or the recess.

In the above-described embodiments, the keyboard unit may further include a cover fixed to a lower surface of the first planar portion and a lower surface of the second planar portion. The first planar portion and the second planar portion may be spaced from each other. The cover may cover the space separating the first planar portion and the second planar portion, and separated from the stopper installation portion.

Obviously, numerous modifications and variations of the present disclosure are possible in light of the above teachings. It is therefore to be understood that within the scope of the appended claims, the present disclosure may be practiced otherwise than as specifically described herein.

What is claimed is:

1. A keyboard unit comprising:
a planar member;
a frame supported by and attached to the planar member;
a key connected to the frame;
a hammer assembly rotationally movably mounted to the frame; and
a stopper configured to restrict a rotational and downward movement of the hammer assembly,
wherein the stopper is softer in hardness than the frame, and
wherein at least part of the stopper is disposed below an upper surface of the planar member.

2. The keyboard unit according to claim 1, wherein:
the planar member includes a first planar portion and a second planar portion,
the frame is supported by and connected to the first planar portion and the second planar portion,
at least the part of the stopper is disposed below an upper surface of the first planar portion and an upper surface of the second planar portion, and
the stopper is disposed between the first planar portion and the second planar portion.

3. The keyboard unit according to claim 2, wherein:
the first planar portion and the second planar portion are integrally formed with the planar member,
the planar member includes one of a through hole or a recess that spaces the first planar portion and the second planar portion from each other, and
at least the part of the stopper is disposed in a region defined between a side wall of the first planar portion and a side wall of the second planar portion, the side wall of the second planar portion facing the side wall of the first planar portion across the through hole or the recess.

4. The keyboard unit according to claim 2, wherein:
the frame includes a stopper installation portion,
the stopper is fixed to the stopper installation portion,
the stopper installation portion is disposed:
below the upper surface of the first planar portion and the upper surface of the second planar portion; and
between the first planar portion and the second planar portion.

5. The keyboard unit according to claim 2, wherein:
the first planar portion and the second planar portion are integrally formed with the planar member,
the planar member includes a recess that spaces the first planar portion and the second planar portion from each other, and
wherein the stopper is fixed to a bottom of the recess.

6. The keyboard unit according to claim 2, further comprising:
a cover fixed to at least one of a lower surface of the first planar portion or a lower surface of the second planar portion,
wherein the first planar portion and the second planar portion are spaced from each other, and
wherein the cover covers at least part of the space separating the first planar portion and the second planar portion.

7. The keyboard unit according to claim 2, further comprising:
a cover fixed to a lower surface of the first planar portion and a lower surface of the second planar portion,
wherein the first planar portion and the second planar portion are spaced from each other,
wherein the cover covers the space separating the first planar portion and the second planar portion, and
wherein the stopper is fixed to the cover.

8. The keyboard unit according to claim 2, wherein:
the first planar portion and the second planar portion are integrally formed with the planar member, and
the planar member is made of wood material.

9. A keyboard unit comprising:
a planar member;
a frame supported by and attached to the planar member;
a key connected to the frame; and
a hammer assembly disposed above the first planar portion and rotationally movable so that part of the hammer assembly is movable below an upper surface of the planar member.

10. The keyboard unit according to claim 9, wherein:
the planar member includes a first planar portion and a second planar portion,
the frame is supported by and connected to the first planar portion and the second planar portion, and
the part of the hammer assembly is movable below an upper surface of the first planar portion, between the first planar portion and the second planar portion.

11. The keyboard unit according to claim 10, further comprising:
a stopper configured to restrict a rotational and downward movement of the hammer assembly, the stopper being softer in hardness than the frame,
wherein at least part of the stopper is also disposed below the upper surface of the first planar portion and an upper surface of the second planar portion, between the first planar portion and the second planar portion.

12. The keyboard unit according to claim 10, wherein:
the first planar portion and the second planar portion are integrally formed with the planar member,
the planar member includes one of a through hole or a recess that spaces the first planar portion and the second planar portion from each other, and
the part of the hammer assembly is rotationally movable to a region defined between a side wall of the first planar portion and a side wall of the second planar portion, the side wall of the second planar portion facing the side wall of the first planar portion across the through hole or the recess.

13. The keyboard unit according to claim 11, wherein:
the first planar portion and the second planar portion are integrally formed with the planar member,
the planar member includes one of a through hole or a recess that spaces the first planar portion and the second planar portion from each other, and
the part of the hammer assembly is rotationally movable to a region defined between a side wall of the first planar portion and a side wall of the second planar portion, the side wall of the second planar portion facing the side wall of the first planar portion across the through hole or the recess.

14. The keyboard unit according to claim 11, wherein:
the frame includes a stopper installation portion,
the stopper is fixed to the stopper installation portion, and
the stopper installation portion is disposed below the upper surface of the first planar portion and the upper surface of the second planar portion, between the first planar portion and the second planar portion.

15. The keyboard unit according to claim 11, wherein:
the first planar portion and the second planar portion are integrally formed with the planar member,
the planar member includes a recess that spaces the first planar portion and the second planar portion from each other, and
the stopper is fixed to a bottom of the recess.

16. The keyboard unit according to claim 10, further comprising:
a cover fixed to at least one of a lower surface of the first planar portion or a lower surface of the second planar portion,
wherein the first planar portion and the second planar portion are spaced from each other, and
wherein the cover covers at least part of the space separating the first planar portion and the second planar portion.

17. The keyboard unit according to claim 11, further comprising:
a cover fixed to at least one of a lower surface of the first planar portion or a lower surface of the second planar portion,
wherein the first planar portion and the second planar portion are spaced from each other,
wherein the cover covers at least part of the space separating the first planar portion and the second planar portion.

18. The keyboard unit according to claim 14, further comprising:
a cover fixed to the stopper installation portion and to at least one of a lower surface of the first planar portion or a lower surface of the second planar portion,
wherein the first planar portion and the second planar portion are spaced from each other, and
wherein the cover covers at least part of the space separating the first planar portion and the second planar portion.

19. The keyboard unit according to claim 14, further comprising:
a cover fixed to a lower surface of the first planar portion and a lower surface of the second planar portion,
wherein the first planar portion and the second planar portion are spaced from each other, and
wherein the cover covers the space separating the first planar portion and the second planar portion, and separated from the stopper installation portion.
